(19) United States
(12) Patent Application Publication
(10) Pub. No.: US 2021/0231970 A1
(43) Pub. Date: Jul. 29, 2021

(54) CLIP-ON GLASSES SYSTEM AND CARRY CASE FOR SAME

(71) Applicant: Eric Radzwill, Oakland Park, FL (US)

(72) Inventor: Eric Radzwill, Oakland Park, FL (US)

(21) Appl. No.: 17/229,034

(22) Filed: Apr. 13, 2021

Related U.S. Application Data
(63) Continuation of application No. 15/994,710, filed on May 31, 2018.
(60) Provisional application No. 62/603,441, filed on May 31, 2017.

(51) Int. Cl. G02C 3/04; H04B 1/3888; A45F 5/10; G02C 5/00; A45C 15/00; A45C 11/04; G02C 5/12; A45C 11/00

(52) U.S. Cl. CPC G02C 3/04; H04B 1/3888; A45F 5/10; G02C 5/006; H04M 1/04; A45C 11/04; G02C 5/128; A45C 11/00; A45F 2005/1086; A45C 15/00

(57) ABSTRACT

A clip-on glasses system includes clip-on glasses and a carry case for carrying and storing the clip-on glasses. The clip-on glasses lack conventional temple members and are instead a generally planar arrangement of two lens portions connected by a flexible bridge which allows a user to “clip” the glasses onto the user's nose such that a spring action of the bridge causes the lens portions together against the user's nose on opposite sides of the user's nose. The flexible bridge is made in a serpentine arrangement that augments the flexibility over bridge configurations and provides an easy hand hold for grasping the clip-on glasses. The carry case is configured to use the spring action of the flexible bridge to retain the clip-on glasses in the carry case, and has a stand to stand the carry case upright.

### CROSS-REFERENCE TO RELATED APPLICATION

This application is a continuation in part of U.S. patent application Ser. No. 15/994,710, filed May 31, 2018, and further claims priority through that application to U.S. Provisional Patent Application No. 62/603,441 filed May 31, 2017, the entireties of each of which are hereby incorporated by reference.

### FIELD OF THE INVENTION

The present invention relates generally to a system for clip-on glasses that lack temple arm members and that are configured to clip onto a user's nose, and a carry case for such clip-on glasses, and more particularly to a system in which the carry case is configured to be easily carried and which allow easy access to the clip-on glasses when in the carry case.

### BACKGROUND OF THE INVENTION

Cellular phones and other handheld mobile devices are in widespread use, to the point that many people carry such a device everywhere they go. These devices have become much more than merely a wireless telephone. As these devices have evolved over time their form factor has changed, based on how people have used them in the past. Presently, the most common form factor is a tablet format, with the device being generally rectangular with the majority of the front surface being dedicated to a graphical display, with buttons and connector being on the sides. This format is generally preferred as it makes presentation of information on the display easier to read and interact with, which is the kind of activity that these devices have come to be predominantly used.

The rectangular, tablet form factor, while useful for presenting information, doesn't lend itself well to being held for interacting with the device, i.e. using fingers to enter information, select items, etc. As a result, there have been a number of accessories developed to assist a user in holding their mobile device. One of the more popular accessories is a “pop up” stand/holder that includes a base that adheres to the back of the device or a case in which the device is held, and has a top portion that can extend away from the base by a collapsible structure between the top and base portions. When not in use the structure can be collapsed with the that the top portion is against the case, minimizing its profile for carrying in a pocket, hand, purse, etc. To hold the device, the structure can be extended to slide between a user's fingers to facilitate holding the device, or to support the device on a surface as a stand.

The increasingly common use of mobile devices also presents a challenge to people who are older, and may have some difficulty reading or viewing information on the relatively small area of the display. It is quite common for people, as they mature, to have a need for reading glasses, including for reading or viewing their mobile device, comfortably. Reading glasses are not typically worn at all times, like glasses for correcting myopia. As such, people who have trouble reading will often carry reading glasses with them, which is not always convenient. Further, conventional glasses are subject to damage when carried unless carried in a case, but a case for conventional glasses is also awkward to carry as they tend to be on the order of five to six inches long, two inches across, and one and half inches high. A much smaller form factor would be easier to carry.

Accordingly, there exists a need to overcome the problems associated with the prior art as discussed above.

### SUMMARY OF THE INVENTION

The invention provides a clip-on glasses system that overcomes the hereinafore-mentioned disadvantages of the heretofore-known devices and methods of this general type and that further includes a carry case configured to carry and retain a pair of clip-on glasses.

In accordance with some embodiments of the inventive disclosure, there is provided a clip-on glasses system that includes a pair of clip on glasses having a right lens portion and a left lens portion that are joined by a flexible bridge having a serpentine shape. The serpentine shape includes a plurality of upward and downward undulations, including a middle upward undulation. The pair of clip on glasses has a maximum width across the right and left lens portions. The system further includes a carry case for receiving and retaining the pair of clip-on glasses that has a front wall and a rear wall that are parallel. The carry case further includes a sidewall that extends between the front wall and rear wall around a bottom of the front wall and rear wall, and which extends upward around a right side and a left side of the front wall and rear wall to a right side end point and a left side end point. A distance between the left side end point and the right side end point is less than the maximum width across the right and left lens portions of the clip-on glasses and is less than a maximum distance from a left side to a right side inside the carry case. The maximum distance from the left side to the right side inside the carry case is closer to a bottom of the carry case than are either the right side end point and left side end point of the sidewall. The carry case has a top indent portion form along a top of the carry case that is configured such that the middle upward undulation of the clip on glasses is exposed by the top indent when the clip-on glasses are fully inserted into the carry case.

In accordance with another feature, the carry case further includes a stand disposed on the rear wall and including a stand member having an attached end that is attached to the rear wall of the carry case at a hinge, and further having a free end opposite the attached end.

In accordance with another feature, the stand member is a ring.

In accordance with another feature, the free end of the ring has a flat outer portion.

In accordance with another feature, the hinge is a pivot hinge.

In accordance with another feature, an inside surface of each of the front and rear walls are covered by a respective liner layer.

In accordance with another feature, the liner layer is made of felt.

In accordance with another feature, the carry case further includes a bottom indent opposite the top indent, and wherein the top indent follows a parabolic curve along the top of the carry case and the bottom indent follows a parabolic curve along a bottom of the carry case.

In accordance with another feature, the top indent is configured such that only the middle upward undulation of the flexible bridge of the clip-on glasses is exposed by the top indent when the clip-on glasses are fully inserted into the carry case.

In accordance with another feature, the middle upward undulation of the flexible bridge of the clip-on glasses comprises a lateral extension at a top of the middle upward undulation.

In accordance with some embodiments of the inventive disclosure there is a provided a carry case for receiving and retaining the pair of clip-on glasses that has a front wall and a rear wall that are parallel. The carry case further includes a sidewall that extends between the front wall and rear wall around a bottom of the front wall and rear wall, and which extends upward around a right side and a left side of the front wall and rear wall to a right side end point and a left side end point. A distance between the left side end point and the right side end point is less than the maximum width across the right and left lens portions of the clip-on glasses and is less than a maximum distance from a left side to a right side inside the carry case. The maximum distance from the left side to the right side inside the carry case is closer to a bottom of the carry case than are either the right side end point and left side end point of the sidewall. The carry case further includes a stand disposed on the rear wall and including a stand member having an attached end that is attached to the rear wall of the carry case at a hinge, and further having a free end opposite the attached end. The carry case has a top indent portion form along a top of the carry case that is configured such that the middle upward undulation of the clip on glasses is exposed by the top indent when the clip-on glasses are fully inserted into the carry case.

Although the invention is illustrated and described herein as embodied as a clip-on glasses system and a carry case, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of” the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the movement of the collapsible member. Those skilled in the art can understand the specific meanings of the above-mentioned terms in the embodiments of the present invention according to the specific circumstances

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 shows an isometric view of a holder and stand accessory having a pocket for holding eyeglasses, in accordance with some embodiments;

FIG. 2 shows a side elevational view of a holder and stand accessory having a pocket for holding eyeglasses, in accordance with some embodiments;

FIG. 3 shows a side cut-away view of a holder and stand accessory having a pocket for holding eyeglasses, in accordance with some embodiments;

FIG. 4 shows a use diagram illustrating how eyeglasses are kept in a holder and stand accessory, in accordance with some embodiments;

FIG. 5 shows a use diagram illustrating how eyeglasses are kept in a holder and stand accessory, in accordance with some embodiments;

FIG. 6 shows a side elevational view of a holder and stand accessory having a pocket for storing eyeglasses, in accordance with some embodiments;

FIG. 7 shows a side portion diagram of a base and a foot of a holder and stand accessory and retaining features for retaining the accessory in a collapsed state, in accordance with some embodiments;

FIG. 8 shows a side elevational view of a holder and stand accessory having an eyeglass pocket in the base of the accessory, in accordance with some embodiments;

FIG. 9A shows a perspective view, generally from the bottom, of an exemplary holder and stand accessory including a pocket for holding folded eyeglasses, in an extended state, in accordance with some embodiments;

FIG. 9B shows a perspective view, generally from the bottom, of an exemplary holder and stand accessory including a pocket for holding folded eyeglasses, in a closed state, in accordance with some embodiments;

FIG. 9C shows a perspective cut-away view, generally from the top, of an exemplary holder and stand accessory including a pocket for holding folded eyeglasses, in a closed state, in accordance with some embodiments;

FIG. 9D shows a perspective cut-away view, generally from the top, of an exemplary holder and stand accessory including a pocket for holding folded eyeglasses, in an expanded state, in accordance with some embodiments;

FIG. 9E shows a perspective view, generally from the top, of an exemplary holder and stand accessory including a pocket for holding folded eyeglasses, in a closed state, with the eyeglasses out of the pocket, in accordance with some embodiments;

FIG. 10 shows a side elevational cut-away view of a holder and stand accessory including one or more magnets, in accordance with some embodiments;

FIG. 11 shows rear view of a clip-on glasses system including a carry case having a stand, in accordance with some embodiments;

FIG. 12 shows a rear side perspective view of the carry case in a standing position, in accordance with some embodiments;

FIG. 13 shows a rear side perspective view of the clip-on glasses system with the clip-on glasses partly inserted into the carry case while the carry case is in a standing position, in accordance with some embodiments;

FIG. 14 shows a front side and top perspective view of the clip-on glasses system with the glasses fully inserted into the carry case, in accordance with some embodiments;

FIG. 15 shows a rear elevational view of the clip-on glasses system with the glasses fully inserted into the carry case, in accordance with some embodiments;

FIG. 16 shows a side cutaway view of a carry case for clip-on glasses system along line AA of

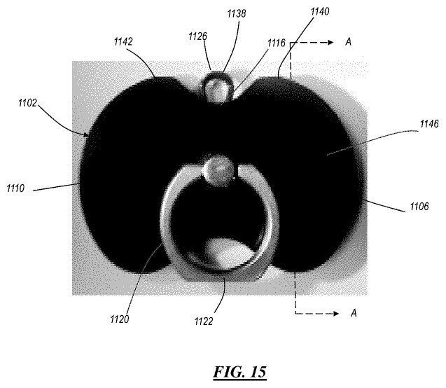

FIG. 15, in accordance with some embodiments;

FIG. 17 shows a rear elevational view of carry case for a clip-on glasses system, in accordance with some embodiments;

FIG. 18 shows a side view of the carry case shown in FIG. 17 in a standing configuration, in accordance with some embodiments;

FIGS. 19A-C show the insertion of the clip-on glasses into a carry case, in accordance with some embodiments; and

FIG. 20 shows several configurations of a stand member attached to the carry case, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient mobile device accessory in the form of a “pop up” collapsible holder and stand that attaches to the back of the mobile device, and includes a pocket that is configured to hold and retain a pair of folding nose clip-on type eyeglasses. Embodiments of the invention provide an accessory having a base configured to attach to the back of a mobile device or the case of a mobile device. A collapsible member is attached to the base at a first end of the collapsible member, and to a foot at a second end of the collapsible member, allowing the foot to be extended for use or retained against the base when not in use. The eyeglass pocket is formed in the foot, or the base, or both (for different prescriptions).

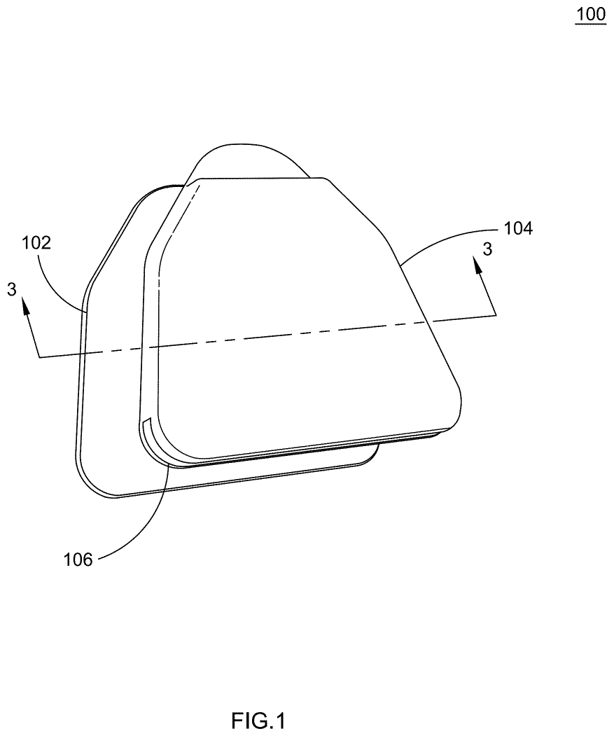

FIG. 1 shows an isometric view of a holder and stand accessory 100 having a pocket for holding eyeglasses, in accordance with some embodiments. Specifically, the holder and stand accessory 100 is a “pop-up” type of accessory that is configured to be mounted or attached on the back of a mobile device that can be collapsed when not in use, and expanded to facilitate holding the mobile device, or to use as a stand to orient the mobile device in a position other than lying on its back on a surface so that a person can look more directly at the front of the mobile device. Such pop-up accessories are common, but provide no other function. The holder and stand accessory includes a base 102 and a foot 104 that can move vertically relative to each other. That is, the base 102 and foot 104 are each generally planar elements and each define planes that are parallel to each other, and the base 102 and foot 104 can move in a direction perpendicular to those defined planes. The base 102 is configured to be mounted or attached to the back of a mobile device (i.e. the side opposite the graphical display). The base 102 can be attached by an adhesive layer of material, or by interfacing with a mechanical retention feature (e.g. a mount). The foot 104, when extended, can rest against a surface on which the mobile device is resting to hold the mobile device so that the user can more easily see the display of the mobile device, or the foot 104 can act as a hold against which the user's fingers bear while holding and interacting with the mobile device. The base 102 and the foot 104 are joined together by a collapsible member (not seen in this view) that supports the foot 104, when extended, in some embodiments. In some embodiments the base can simply be the bottom of the collapsible member.

Within the foot 104 is a pocket, formed by a hollow space between the top and bottom of the foot 104. The pocket is accessible by a slot 106 on the side of the foot 104. The pocket is sized to hold a pair of eyeglasses that are a folding, clip on type of eyeglasses. The eyeglasses can sit in, and be retained in the pocket with a portion extending out the other side 108 from the slot 106.

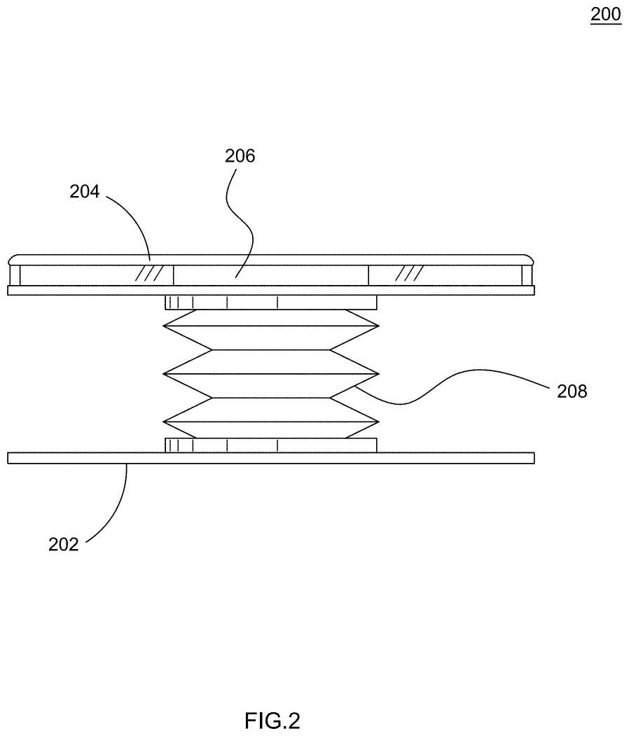

FIG. 2 shows a side elevational view of a holder and stand accessory 200 having a pocket 206 for holding eyeglasses, in accordance with some embodiments. The accessory 200 shown here can be substantially similar to that shown in FIG. 1. The accessory 200 includes a base 202 and a foot 204 which are coupled together by a collapsible member 208. As shown here, the collapsible member 208 is formed using an accordion configuration that allows portions of the collapsible member to fold over each other when collapsed. Furthermore, the collapsible member 208 is formed in a generally cylindrical form factor, where the segments all have the same width. The collapsible member 208 allows the foot 204 to move relative to the base 202. As shown here, the base 202 and foot 204 define planes that are parallel, and perpendicular to the direction of movement of the collapsible member. The collapsible member 208 can be formed such that the segment defined by the folds of the collapsible member, when embodied in an accordion format as shown here, the segments can be configured such that when compressed and closed, the segments are self-biased to remain collapsed. Likewise, the segments of the collapsible member 208 can be configured to be biased to remain open when the foot is moved away from the base. A slot opens into the interior space forming a pocket 210 between the top and bottom of the foot, the top being the uppermost wall in this view, and the bottom being the lowermost wall to which one end of the collapsible member 208 is attached or coupled. Another slot 206 can be seen through the slot and the pocket 210. The eyeglasses can be placed into the pocket and retained therein until a user retrieves them from the pocket 210 for use.

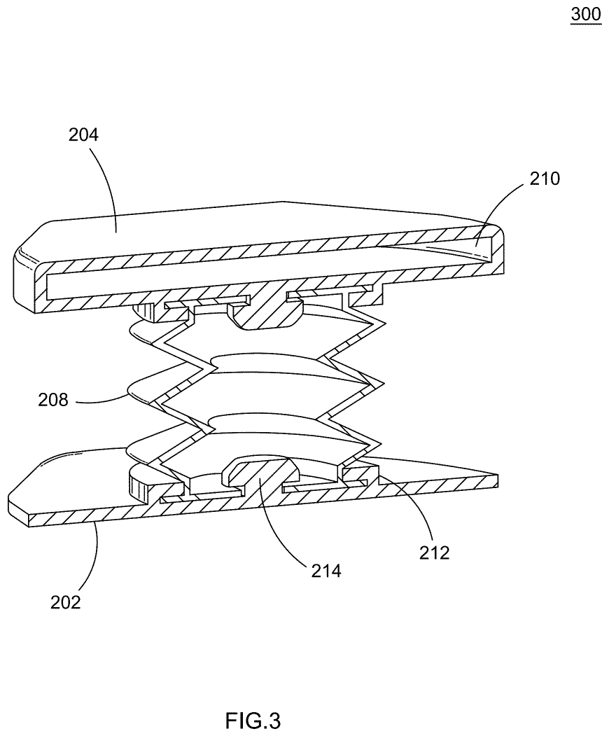

FIG. 3 shows a side cut-away view of a holder and stand accessory 200 having a pocket for holding eyeglasses, in accordance with some embodiments. This view shows an example of the accessory 200 of FIG. 2 cut-away to show the collapsible member 208 is hollow and attached at a first end to the base 204 and at a second end to the bottom of the foot 204. In some embodiments the collapsible member 208 can be attached with retaining features such as a ledge 212 and a flared post 214 that interfere with a end wall of the collapsible member 208.

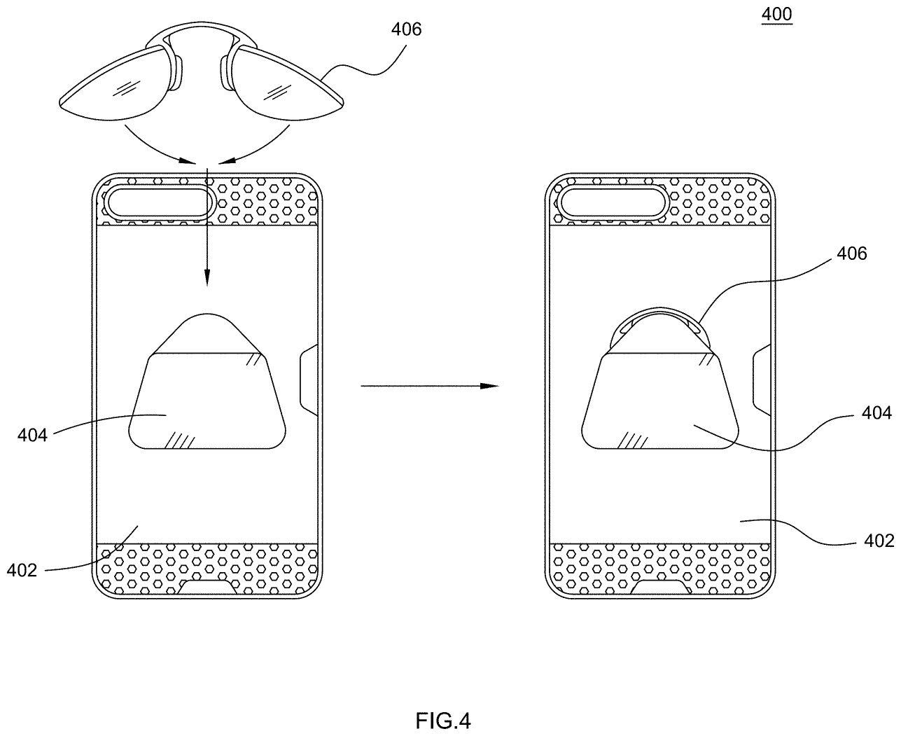

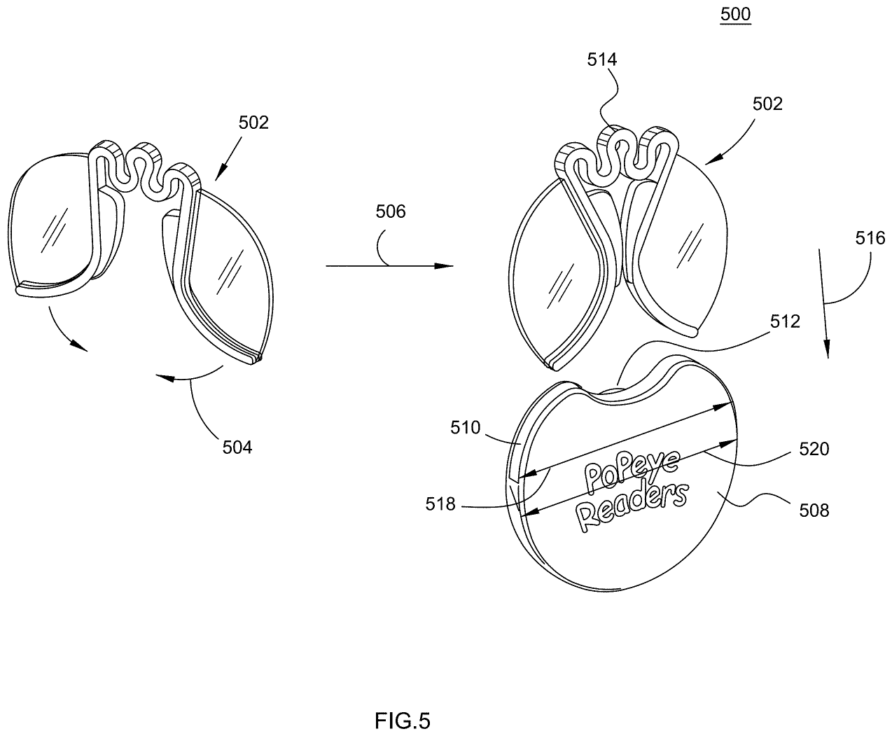

FIG. 4 shows a use diagram 400 illustrating how eyeglasses are kept in a holder and stand accessory, in accordance with some embodiments. On the left, the eyeglasses 406 are outside of the pocket of the holder and stand accessory 404 that is mounted on the back of a mobile device 402. The holder and stand accessory 404 can be substantially similar to that of FIGS. 1-3. The eyeglasses 406 have a flexible bridge between the lenses and no temple/ear portions. Rather, the eyeglasses bend to allow the user to clip them onto the bridge of the user's nose, and the spring action of the flexible bridge produces a resulting inward force as a result of being spread apart by the bridge of the user's nose. As a result, the static friction created by the force holds the eyeglasses on the user's nose. When not in use, the lens portions of the eyeglasses can be folded in toward each other, in the plane defined by the lenses, bending the bridge, and the folded eyeglasses can then be inserted into the pocket in the foot of the holder and stand accessory, and shown on the right side of the diagram. The spring action of the bridge of the eyeglasses 406 can urge the lenses outward, against the sides of the pocket, which are the sides of the foot. The resulting force against the inside of the pocket can act to retain the eyeglasses 406 in the pocket. Thus, the pocket in the foot can be shaped, in consideration of the shape of the folded eyeglasses 406, to provide retention of the folded eyeglasses 406.

FIG. 5 shows a use diagram 500 illustrating how eyeglasses are kept in a holder and stand accessory, in accordance with some embodiments. In this view a different form factor of the eyeglasses 502 and the foot 508 are shown. The eyeglasses 502 can be folded by moving the lenses in the direction of arrow 504. Once folded, the folded eyeglasses can be moved (506) to place them into the pocket in the foot 508, though a slot 510, in the direction of arrow 516. In embodiments consistent with those of FIG. 5, the foot 508 can be substantially circular in the plane defined by the major surface of the foot 508. The slot 510 can have a slot width 518 that is less than a maximum pocket width 520, which creates a retaining structure for the folded eyeglasses 502 to retain them in the pocket. The bridge 514 of the eyeglasses 502 acts as a spring, urging the lenses outward against the sidewalls of the pocket/sidewall. An indented portion 512 of the foot 508 can allow a user to grasp the bridge 514 when the folded eyeglasses 502 are in the pocket, to remove the eyeglasses 502 from the pocket. The foot 508 is attached to a base by a collapsible member such as in FIGS. 1-3, and the base can be attached to or otherwise mounted on a mobile device or a case of a mobile device.

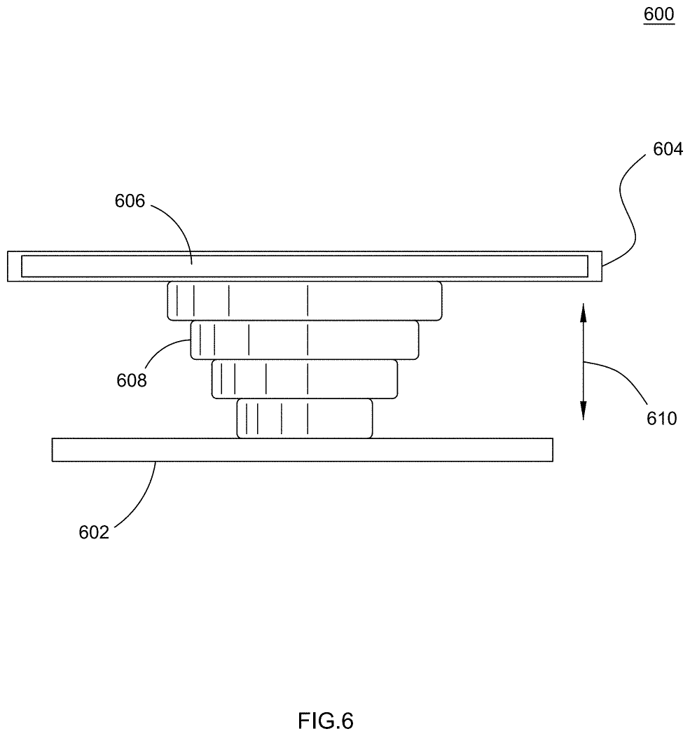

FIG. 6 shows a side elevational view of a holder and stand accessory 600 having a pocket 606 for storing eyeglasses, in accordance with some embodiments. A base 602 is configured to be attached or mounted to a mobile device. A collapsible member 608 is coupled to the base at a first end of the collapsible member 608, and is further coupled to a foot 604 at a second end of the collapsible member. In embodiments consistent with those represented by FIG. 6, the collapsible member 608 is conically shaped. As shown here the collapsible member 608 is extended, and when the collapsible member 608 is collapsed, when the foot 604 is moved in the direction of arrow 610, the segments of the collapsible member 608 collapse concentrically around each other.

Thus, there are a variety of collapsible member configurations that can be used equivalently. In some embodiments the collapsible members can have an accordion configuration, including accordion configurations that retain their shape when extended or collapsed. In some embodiments the collapsible member can be conically shaped, using a similar accordion operation, to collapse the segments concentrically. In some embodiments a coil spring can be used as the collapsible member, or to urge the foot away from the base.

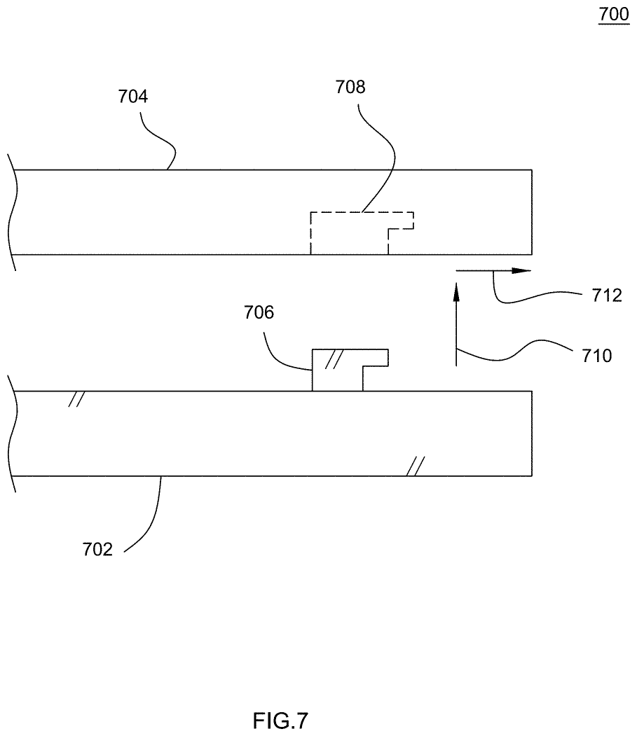

FIG. 7 shows a side portion diagram 700 of a base 702 and a foot 704 of a holder and stand accessory and retaining features for retaining the accessory in a collapsed state, in accordance with some embodiments. Specifically a side wall of the base is shown that can extend upward from the main portion of the base 702, and can include a finger 706. In some embodiments a spring may be used to urge the foot 704 away from the base 702 to an extended state or position, and the user must push in the base 704 to compress the spring. The base can have a corresponding retaining ledge structure 708 to engage the finger 706 upon the user causing finger 706 to enter the ledge structure 708, as indicated by arrow 710, and the rotating the foot 704 as indicated by arrow 712 to engage the finger 706 in the ledge 708, retaining the foot 704 to the base 702. A variety of different retaining features similar to that shown here can be realized equivalently.

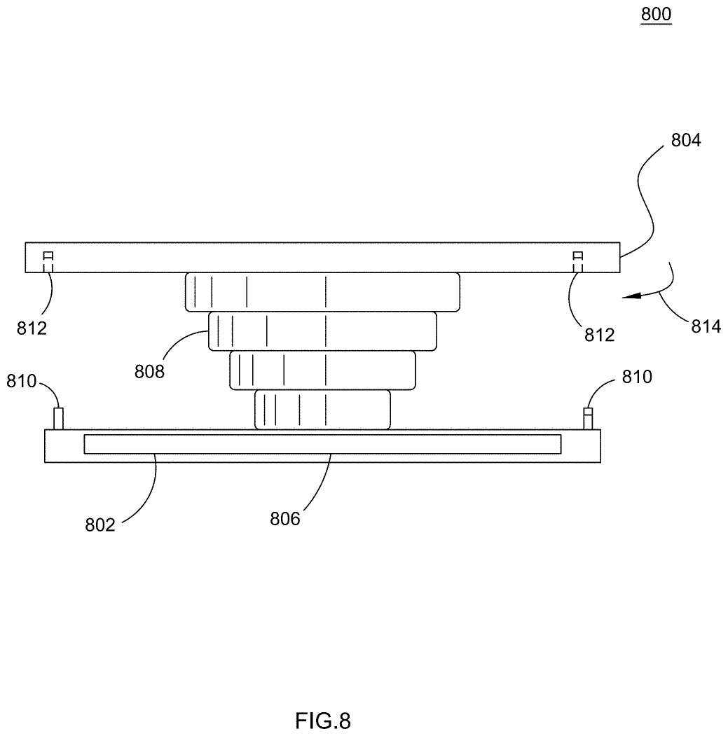

FIG. 8 shows a side elevational view of a holder and stand accessory 800 having an eyeglass pocket 806 in the base 802 of the accessory, in accordance with some embodiments. The base 802 is configured to be attached to a mobile device, such as by adhesive or a mechanical mount, and includes a pocket 806 accessible by a slot opening in which folded eyeglasses can be inserted for retention and keeping until the user removes them for use. In this respect the pocket 806 an be substantially similar to that shown and described in reference to FIGS. 1-6. A collapsible member 808 is attached to the top of the base 802 at a first end of the collapsible member, and to a foot 804 at a second end of the collapsible member. The collapsible member 808 shown here is a conical, concentrically collapsing member, but any collapsible member suitable for the function described herein can be used, as is the case with the embodiments represented in FIGS. 1-6. The base can include finger structures 810 that mate with corresponding ledge structure 812 for retaining the foot 804 when the accessory is in a collapsed state. To engage the fingers 810 into the ledge structures 812 upon collapsing the accessory so that the foot 804 is against the base 802, the foot can be rotated as indicated by arrow 814 when collapsed.

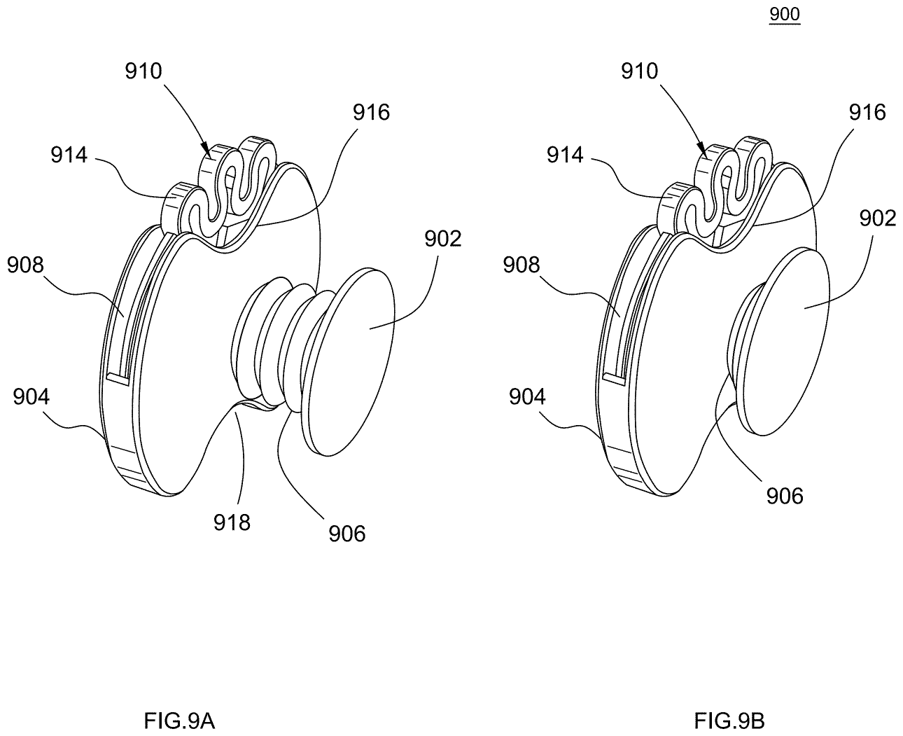

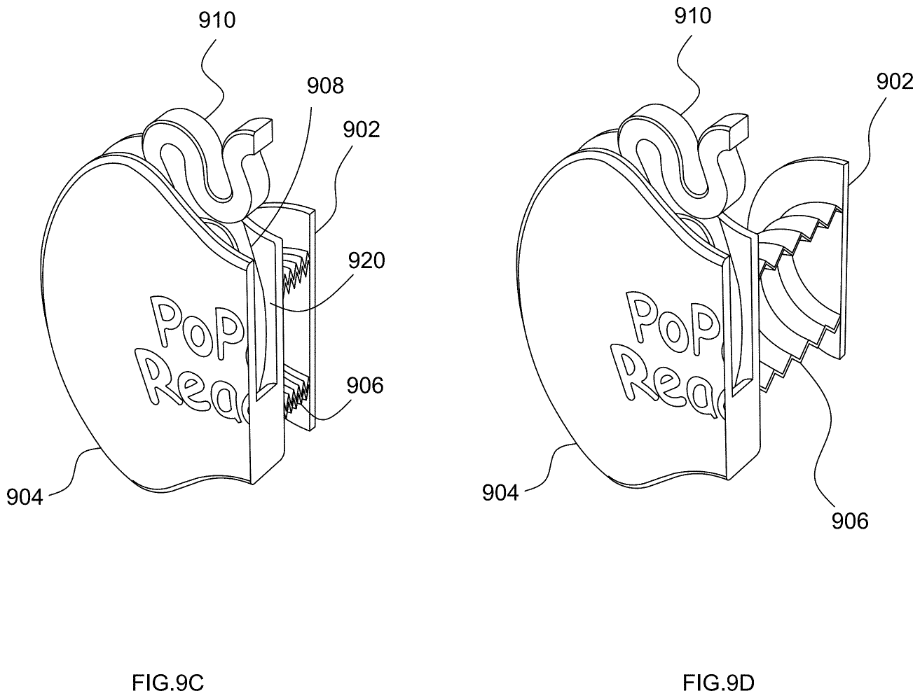

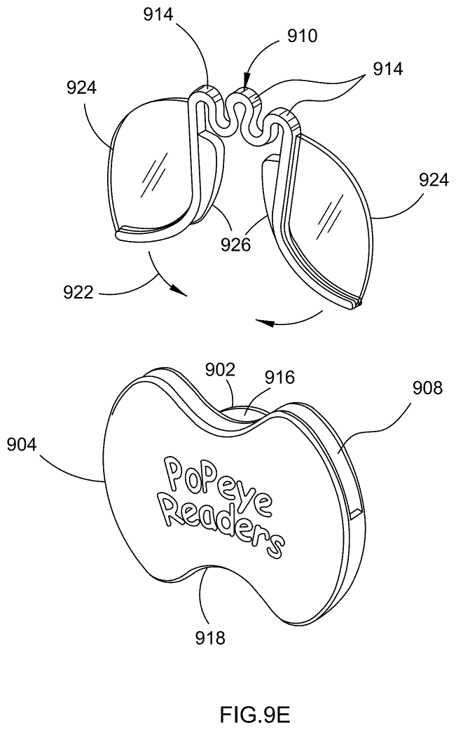

FIGS. 9A-9E show various views of an exemplary holder and stand accessory for use with a mobile device, to hold a pair of folding nose clip-on eyeglasses. FIG. 9A shows a perspective view, generally from the bottom, of an exemplary holder and stand accessory 900 including a pocket 920 for holding folded eyeglasses, in an extended state, in accordance with some embodiments. FIG. 9B show the holder and stand accessory 900 from the same perspective as FIG. 9A in the collapsed state. FIGS. 9C and 9D show the holder and stand accessory 900 from a different perspective, generally from the top, and in cut-away, in the collapsed and expanded states, respectively. FIG. 9E shows the holder and stand accessory 900 in a top perspective view in the collapsed state, and with the eyeglasses outside the accessory being folded to be placed into the pocket in the foot of the accessory.

The accessory 900 includes a base 902 and a foot 904 that are connected together by a collapsible member 906. The foot 904 includes a slot 908 that allows access to a pocket 920 formed inside the foot 904, into which a folded pair of eyeglasses 910 can be kept. The collapsible member 906 shown here is formed a cylindrical format with accordion type walls to allow the collapsible member to be expanded and collapsed. The base 902 is configured to be mounted on or attached to a mobile device. The foot 904 shown here has a “bow tie” plan profile with an upper indentation 916 and a lower indentation 918 in an otherwise generally circular shape. The eyeglasses 910 include a bridge formed of one or more cantilevered lobe segments 914 the provide a range of bending that is greater than a simple straight spring segment, and which also form a handle for the user to hold the eyeglasses 910 when inserting them into the pocket 920 and removing them from the pocket. The indent 916 exposes the bridge of the eyeglasses 910 for easier grasp by the user. The eyeglasses 910, as seen in FIG. 9E, include lenses 924 mounted in structure including the bridge, and are designed to “clip-on” to a user's nose at the bridge of the nose, where nose pads 926 contact the user's nose and the cantilevered lobe segments provide an inward force, causing the nose pads 926 to grip the user's nose and thereby be retained on the user's nose. To fold the eyeglasses 910, the left and right sections with their respective lenses 924 can be moved together, as indicated by arrows 922, so that the eyeglasses 910 can be inserted through the slot 908 into the pocket 920 in the foot 904.

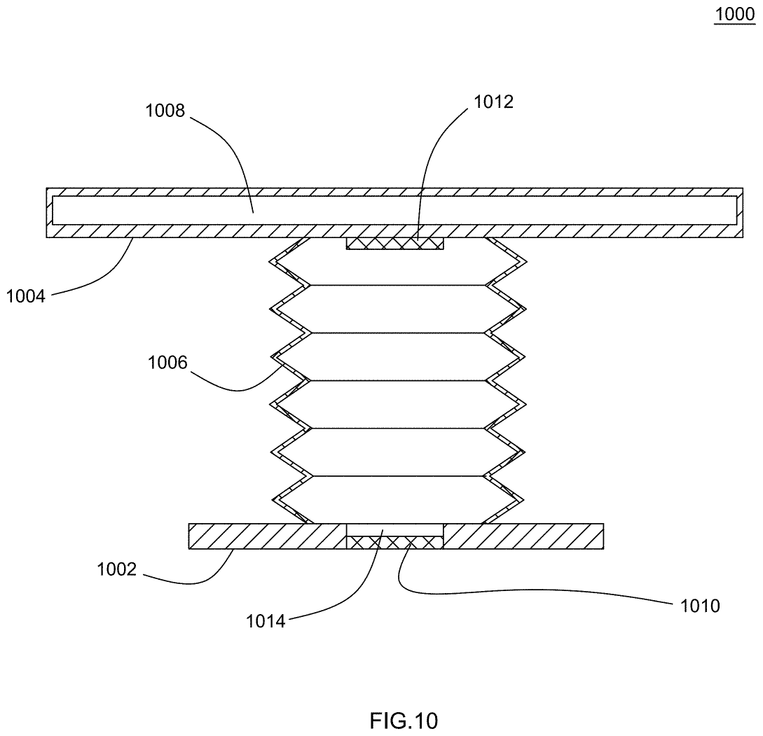

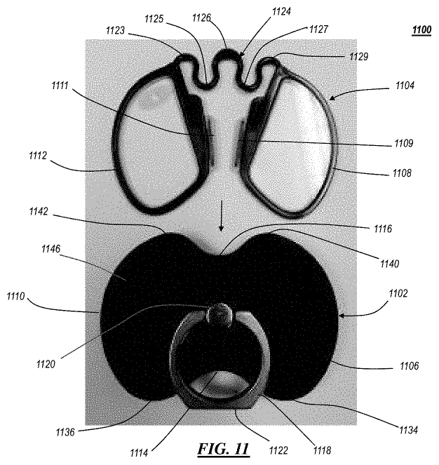

FIG. 10 shows a side elevational cut-away view of a holder and stand accessory 1000 including one or more magnets, in accordance with some embodiments. The accessory 1000 includes a base 1002, a foot 1004, and a collapsible member 1006 connecting the base 1002 and foot 1004 together. The foot 1004 includes a pocket 1008 in which a pair of folding nose clip-on type eyeglasses can be stored and retained. The collapsible member 1006 can be formed in cylindrical form with accordion type segments that allow the collapsible member to be collapsed and expanded. In the expanded state the foot 1004 is moved away from the base 1002 to act as a holder for a person to grasp with their fingers, or as a stand to prop the mobile device up for viewing on a surface. The collapsible member 1006 can be configured to be biased into the expanded state as shown. To retain the foot 1004 in proximity to the base 1002, in the collapsed state, one or more magnets 1010, 1012 can be placed on the base 1002 and foot 1004, respectively, inside the collapsible member 1006. If only one magnet is used, then one of elements 1010, 1012 must be a ferrous metal to attract the magnet. A recess 1014 can be used to provide clearance for one of the magnetic elements and allow space for the collapsible member 1006 in the collapsed state.

FIGS. 11-16 and FIGS. 19A-C show clip-on glasses system, and common reference numerals are used to show the same features in the various views. However not all features are visible in all views, thus reference may be made to some views for a particular described feature that is not shown in other views among FIGS. 11-16 and FIGS. 19A-C. FIG. 11 shows rear view of a clip-on glasses system 1100 including a carry case 1102 having a stand, in accordance with some embodiments. As used herein, the term “clip-on glasses” refers to glasses that lack the conventional temple arms that sit on a wearer's ears, and which instead “clip” onto the user's nose, being retained on the user's nose by a spring action of the bridge of the clip-on glasses that urges the nose pads of the clip-on glasses toward each other when clipped onto the user's nose. The carry case 1102 can be shaped substantially similar to the “foot” 904 of FIGS. 9A-9E, and serves a similar purpose. Specifically, the carry case 1102 is designed to contain a pair of clip-on glasses 1104 for easy carrying, and protection of the clip-on glasses 1104. Further, the carry case 1102 can be stood up for easy access when inserting or removing the clip-on glasses 1104 from the carry case 1102. The carry case 1102 includes a right lobe 1106 into which a right lens portion 1108 fits, and a left lobe 1110 into which the left lens portion 1112 fits, when the clip-on glasses 1104 are inserted into the carry case. The right and left lobes 1106, 1110 are defined by the bottom indent 1114 and the top indent 1116 where the perimeter of the carry case at the bottom and top of the carry case extend inward toward the center of the carry case. Thus, for example, the bottom 1134 of the right lobe 1106, and the bottom 1136 of the left lobe 1110, are both lower, or extend in a direction away from the top of the carry case 1102, more than the bottom indent 1114. Likewise, the top indent 1116 extend inward towards the center of the carry case 1102 relative to the top 1140 of the right lobe 1106 and the top 1142 of the left lobe 1110. The bottom and top indents 1114, 1116 can follow a parabolic curve that is concave inward, whereas the bottoms 1134, 1136 and tops 1140, 1142 of the right and left lobes 1106, 1110 can be concave outward. Likewise the sides of the carry case 1102 continue the concave outward parabolic curves of the tops 1140, 1142 and bottoms 1134, 1136 of the right and left lobes 1106, 1110. These curves around the tops 1140, 1142, bottoms 1134, 1136, indents 1114, 1116 and sides give the carry case 1102 its rounded “bow-tie” appearance when viewed from the front or rear, as shown in the drawings.

The clip-on glasses 1104 comprise the right and left lens portions 1108, 1112, which hold lenses. The lenses can be configured to assist a person who may have trouble viewing things close to them, such as when reading. The lens portions 1108, 1112 are joined by a flexible bridge 1124 that has a serpentine configuration. Specifically the bridge 1124 comprises several undulations, generally in the plane of the lens portions 1108, 1112. The undulations comprise alternating up and down portions which give the bridge 1124 more flexibility than if the lens portions 1106, 1110 were joined by a straight bridge that is otherwise similar (e.g. in thickness). The bridge 1124 comprises three upward undulations 1123, 1126, 1129 and two downward undulations 1125, 1127, and is symmetric between the lens portions 1108, 1110 with one of the upward undulations 1126 being in the center of the bridge 1124. The flexible bridge 1124, while being flexible, also tends to return to a neutral position, and exhibits a spring-like characteristic. Accordingly, a user can move the lens portions 1108, 1112 apart and put the clip-on glasses on the bridge of their nose (gripped by nose pads 1109, 1111), where the spring action of the bridge 1124 will urge the lens portions 1108, 1112 together, thereby putting pressure against the user's nose through nose pads 1109, 1111, retaining the clip-ion glasses on the user's nose. When the user is done wearing the clip-on glasses 1104, they can be inserted into the carry case 1102 through an opening 1128 at the top of the carry case. Upon inserting the clip-on glasses 1104 into the carry case 1102, the sides of the carry case 1102 push slightly against the exterior of the lens portions 1108, 1112, moving them slightly together, causing the flexible bridge 1124 to bend.

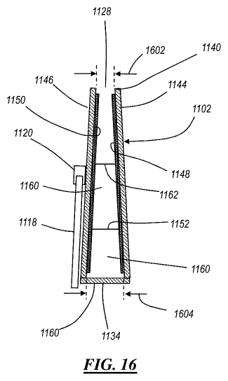

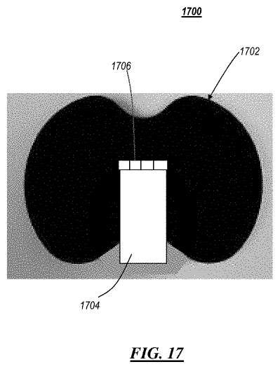

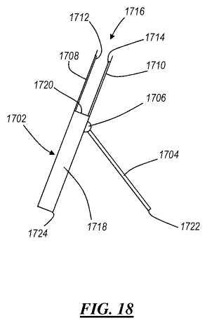

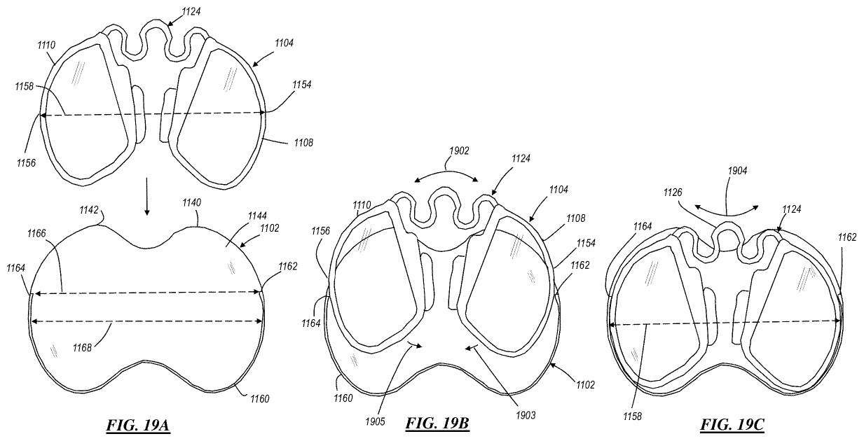

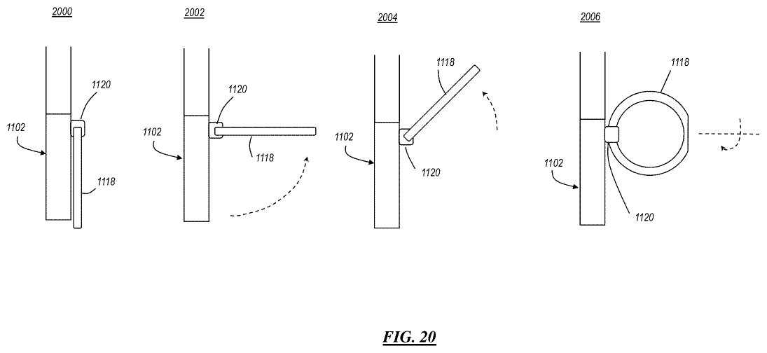

The fitment of the clip-on glasses 1104 into the carry case 1102 are shown in FIGS. 19A-C, which show the progression of inserting the clip-on glasses 1104 into the carry case 1102. In FIG. 19A the clip-on glasses 1104 are full removed from the carry case 1102. In FIG. 19B the clip-on glasses 1104 are partially inserted into the carry case 1102, and the lens portions 1108, 1110 become pushed toward each other by the carry case 1102. In FIG. 19C the clip-on glasses 1104 are fully seated in, and retained by the carry case 1102 by cooperation of the shape of the carry case 1102 and the action of the flexible bridge 1124. In all of FIGS. 19A-C the rear wall (1146) has been removed, leaving the front wall 1144 and the side wall 1160 that extends between the front wall 1144 and the rear wall (1146), as shown, for example, in FIG. 16. The side wall 1160 extends around the bottom of the carry case 1102 and partly up the sides to right and left side end points 1162 and 1164, creating an open gap 1128 between the front wall 1144 and the rear wall (1146). Because the sides of the carry case 1102 are curved, the right and left side end points 1162, 1164 are above the widest part of the carry case 1102. That is, line 1168 indicates the widest portion of the carry case 1102 from side to side, and line 1166 represents the width between the end points 1162, 1164, which is less than the width at line 1168, and the widest portion of the carry case is below (farther from the top 1140, 1142). The clip-on glasses 1104 likewise have a maximum width from side to side at line 1158, between side points 1154, 1156 on the outermost sides of the lens portions 1108, 1110. The width across line 1158 of the clip on glasses 1104 is greater than that of line 1166 between sidewall end points 1162, 1164. The maximum widths of the clip-on glasses 1104 (in a neutral state) across line 1158 and the carry case, across line 1168, can be on the order of two and a half inches, making them very conveniently sized to carry in a pocket, in a person's hand, and so on. Consequently, as seen in FIG. 19B, as the clip-on glasses 1104 are being inserted into the carry case 1102, the side points 1154, 1156 impinge on the sidewall end points 1162, 1164, and further insertion thereby forces the lens portion 1108, 1110 toward each other as indicated by arrows 1903, 1905, slightly bending the flexible bridge 1124 as indicated by line 1902. In FIG. 19C, with the clip-on glasses 1104 fully inserted into the carry case 1102, the flexible bridge 1124, having been bent, now urges the lens portions 1108, 1110 outward, as indicated by line 1904. Since the distance between the sidewall endpoints 1162, 1164 is less than that where the sides (1154, 1158) of the clip-on glasses 1102 sit in the fully inserted position, there is resistance by the clip-on glasses 1102 to exiting the carry case 1102. Thus, the clip-on glasses are retained in the carry case 1102. To remove the clip-on glasses 1104 from the carry case 1102, the user can simply grasp the middle upward undulation 1126 of the flexible bridge 1124 and pull in the upward direction, reversing the sequence of FIGS. 19A-C. It can be seen here that the top indent 1116 exposes the middle upward undulation 1126 for easy grasping by a user, and in some embodiments the top indent 1116 can be configured such that only the middle upward undulation 1124 is exposed when the clip-on glasses 1104 are fully inserted into the carry case 1102.

In order to further make removing and insert the clip-on glasses 1104 from, or into, the carry case 1102, the carry case 1102 can be provided with a stand to position the carry case 1102 in an upright position. The stand can take a variety of forms, but in general the stand is a rigid member attached at one end to one of the major surfaces (front wall or rear wall) of the carry case 1102 and is effectively hinged so that a free end of the rigid member can be extended away from the carry case 1102 to support the carry case in a mostly upright position. For example, as shown in the drawings, a ring 1118 can be attached to a pivot hinge 1120 that is mounted on the outside of the rear wall 1146, in a generally central location of the rear wall 1146. The ring 1118 is one form of a stand which a person's finger can engage with to retain the carry case 1102 in their hand. The ring 1118 coupled to opposing sides of the pivot hinge 1120 and forms a loop in a generally circular shape, and can have a flat portion 1122 at the apex or part of the ring 1118 farther from the pivot hinge 1120, which is the free end of the ring 1118. FIG. 20 shows various positions in which the ring 1118 can be positioned. In configuration 2000 the ring 1118 is laid against the carry case 1102. In configuration 2002 the ring 1118 has been lifted at the free end so that it extends perpendicularly away from the carry case 1102. In configuration 2004 the free end has been lifted further from that of configuration 2002 so that the ring 1118 extends at an angle to the carry case 1102. In configuration 2006 the pivot hinge 1120 has been rotated from configuration 2002 so that the ring 1118 has been correspondingly rotated approximately ninety degrees. The fitment of the ring 1118 to the pivot hinge 1120, and the pivot hinge 1120 to the carry case 1102 can be frictional such that the ring 1118 will tend to stay in whatever position it is lifted/rotated by a user. Thus, the user can chose whatever position of the ring 1118 relative to the carry case 1102 to suit a particular purpose. For example, the user may wish to use configuration 2000 for carrying the carry case 1102 in their pocket.

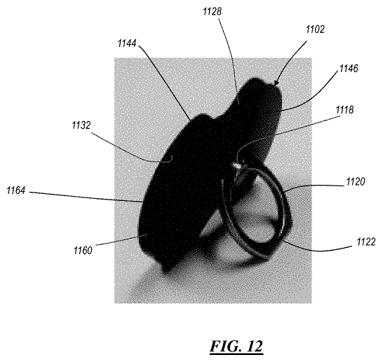

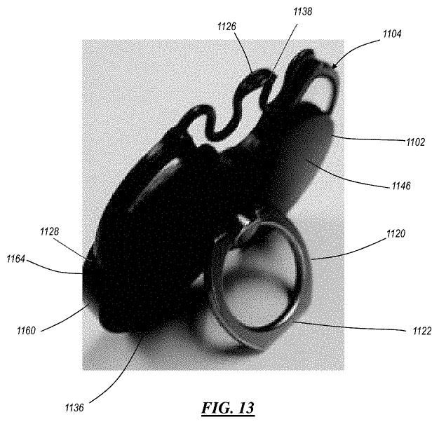

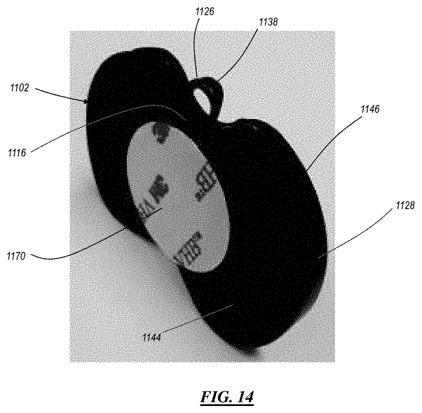

FIGS. 12 and 13 show still another configuration in which the free end (e.g. the flat side 1122) of the ring 1118 is extended about forty five degrees from the carry case 1102 to stand the carry case upright, at a corresponding angle, on a surface. In FIG. 12, the clip-on glasses 1104 are not in the carry case 1102. The opening or gap 1128 between the front wall 1144 and rear wall 1146 into which the clip-on glasses 1104 are inserted can be seen. The gap 1128 is created due to the side wall 1160 ending at end points 1162, 1164 and the front and rear walls 1144, 1146 extending further upward from the height of the end points 1162, 1164. Thus in FIG. 12, the carry case 1102 empty, as in FIG. 19A. In FIG. 13 the clip-on glasses 1104 are partly inserted into the carry case 1102, substantially as shown in FIG. 19B. FIG. 14, shows a frontal view of the carry case 1102 with the clip-on glasses fully inserted, as in FIG. 19C, and with the ring 1118, which can't be seen in FIG. 14, positioned to hold the carry case 1102 upright. FIG. 15 shows the a rear elevational view of the carry case 1102 with the clip-on glasses fully inserted as in FIG. 19C, with the ring 1118 positioned flat against the carry case 1102.

In the drawings, and in particular in FIGS. 13-14, a lateral extension 1138 can be seen which extends laterally away from the middle upward undulation 1126 of the flexible bridge 1124. The lateral extension 1138 assists in pulling the clip-on glasses 1104 from the carry case 1102, and is a shelf-like structure and extends away from the top portion of the middle upward undulation 1126 substantially perpendicularly to the planes of the lens portions 1108, 1112. In FIGS. 14-15 is can be seen that when the clip-on glasses 1104 are fully inserted into the carry case 1102, the tops 1140, 1142 of the carry case lobes 1106, 1110 cover most of the flexible bridge 1124, but the top indent 1116 , which is lower than the tops 1140, 1142, exposes (only) the middle upward undulation 1126 to allow a user to easily grasp the middle upward undulation and pull the clip-on glasses 1104 from the carry case 1102. Covering the other portions of the flexible bridge 1124 reduces the chance of damage to those portions, and capturing the downward undulations 1125, 1127 between the front and rear walls 1144, 1146 of the carry case 1102 provides some rigidity to help prevent damage to the exposed middle upward undulation 1126. Further, in FIG. 14, an adhesive patch 1170 is shown in the outside of the front wall 1144 of the carry case 1102 that can be used to affix the carry case 1102 to a device (e.g. a mobile device or cellular telephone device) wherein the stand element, such as the ring 1118 can act as a stand for the device. The ring 1118 can be sized so that a user can place a finger through the ring to carry the carry case 1102 on their hand, or to hold a device to which the carry case 1102 is affixed.

FIG. 16 shows a side cutaway view of a carry case for clip-on glasses system along line AA of FIG. 15, in accordance with some embodiments. In this view the front and rear walls 1144, 1146, and side wall 1160 have been cut. Since the cut passes through the bottom of the right lobe 1106 of the carry case 1102, the inside of the side wall 1160 can be seen rising to the peak of the bottom indent at 1152, which is the inside of the bottom indent 1114. Further, beyond the bottom indent and point 1152, the sidewall 1160 can be seen extending up to end point 1162. The front and rear walls 1144, 1146 extend further upward from end point 1162 to create a gap 1128. Further, it can be seen that the inside surfaces of the front and rear walls 1144, 1146 are lined with a textile or similarly supple material such as, for example, felt. Thus, front wall 1144 has lining 1148 and rear wall 1146 has lining 1150. The linings 1148, 115 cover the majority of the inside surfaces of the front and rear walls 1144, 1146, particularly where the lenses of the clip-on glasses 1104 will be located when the clip-on glasses 1104 are inserted in the carry case 1102 through gap 1128. The linings 1148, 1150, can prevent the lenses of the clip-on glasses 1104 from being scratched when inserting and removing the clip-on glasses 1104 to/from the carry case. Further, front and rear walls 1144, 1146 can be spaced such that the linings 1148, 1150 remain in contact with portions of the clip-on glasses 1104 to provide some additional, albeit slight, frictional resistance to movement of the clip-on glasses 1104 when inside the carry case 1102. Furthermore, in some embodiments, the front and rear walls 1144, 1146, or the upper portion of the front and rear walls 1144, 1146, can be angled towards each other at the top (e.g. 1140) of the carry case. 1102, such that the width 1602 at the top is greater than the width 1604 at the bottom, which can further serve to help retain the clip-on glasses 1104 when inside the carry case 1102.

FIG. 17 shows a rear elevational view of carry case 1702 for a clip-on glasses system, in accordance with some embodiments. The carry case 1702 include a stand 1704 that is attached to the carry case 1702 at a hinge 1706. FIG. 18 shows the carry case 1704 from a left side view with the stand 1704 positioned to hold the carry case 1702 upright. The stand 1704 can be a substantially planar member, or a member having a different shape. The hinge 1706 allows the stand 1704 to rotate around the hinge 1706 such that the free end 1722 of the stand 1704 can be moved away from the carry case 1702 to hold the carry case upright, resting on the bottom 1724 of the carry case 1702. Similar, if not identical to carry case 1102, carry case 1702 has front and rear walls 1708, 1710, linings 1712, 1714 on the inside of the front and rear walls 1708, 1710, and a sidewall 1718 that ends at a side endpoint 1720, resulting in an open gap 1716 between the front and rear walls 1708, 1710.

A clip-on glasses system has been disclosed that includes a carry case that is specially configured to house, hold, and protect a pair of clip-on glasses so that the carry case and clip on glasses can be easily and comfortably carried by a user. The disclosed carry case is sized to make carrying it easy, so that, for example, it can be carried in a person's shirt or pants pocket, or in their hand. The disclosed carry case further has a stand member that allows a user to stand the carry case substantially upright. In some embodiments the stand can be configured as a ring that can fit over a user's finger for retention of the carry case. The clip-on glasses have a flexible bridge that is partly exposed when the clip-on glasses are in the carry case that facilitates removing and inserting the clip-on glasses from/into the carry case. The bridge can be formed by a series of alternating undulation-shaped portions that effectively increases the flexibility of the bridge over a straight or arced bridge member having otherwise equivalent material and thickness parameters.

What is claimed is:

1. A carry case, comprising:
a front wall and a rear wall that are parallel;
a sidewall that extends between the front wall and rear wall around a bottom of the front wall and rear wall, and which extends upward around a right side and a left side of the front wall and rear wall to a right side end point and a left side end point;
a stand disposed on the rear wall and including a stand member having an attached end that is attached to the rear wall of the carry case at a hinge, and further having a free end opposite the attached end; and
wherein the carry case has a top indent portion form along a top of the carry case.

2. The carry case of claim 1, wherein a distance between the left side end point and the right side end point is less than a maximum distance from a left side to a right side inside the carry case, and wherein the maximum distance from the left side to the right side inside the carry case is closer to a bottom of the carry case than are either the right side end point and left side end point of the sidewall.

3. The carry case of claim 1, wherein the stand member is a ring.

4. The carry case of claim 3, wherein the free end of the ring has a flat outer portion.

5. The carry case of claim 1, wherein the hinge is a pivot hinge.

6. The carry case of claim 1, wherein an inside surface of each of the front and rear walls are covered by a liner.

7. The carry case of claim 6, wherein the liner is made of felt.

8. The carry case of claim 1 wherein the carry case further includes a bottom indent opposite the top indent, and wherein the top indent follows a parabolic curve along the top of the carry case and the bottom indent follows a parabolic curve along a bottom of the carry case.

9. The carry case of claim 1, wherein the carry case is configured to retain a pair of clip-on glasses inside the carry case when the pair of clip-on glasses is inserted into the carry case.

10. A carry case for a pair of clip-on glasses, the clip-on classes having a right lens portion and a left lens portion that are joined by a flexible bridge having a serpentine shape, the serpentine shape including a plurality of upward and downward undulations, including a middle upward undulation, the pair of clip on glasses having a maximum width across the right and left lens portions, the carry case comprising:
a front wall and a rear wall that are parallel;
a sidewall that extends between the front wall and rear wall around a bottom of the front wall and rear wall, and which extends upward around a right side and a left side of the front wall and rear wall to a right side end point and a left side end point, wherein a distance between the left side end point and the right side end point is less than the maximum width across the right and left lens portions of the clip-on glasses and is less than a maximum distance from a left side to a right side inside the carry case, and wherein the maximum distance from the left side to the right side inside the carry case is closer to a bottom of the carry case than are either the right side end point and left side end point of the sidewall;
a stand disposed on the rear wall and including a stand member having an attached end that is attached to the rear wall of the carry case at a hinge, and further having a free end opposite the attached end; and
wherein the carry case has a top indent portion form along a top of the carry case that is configured such that the middle upward undulation of the clip on glasses is exposed by the top indent when the clip-on glasses are fully inserted into the carry case.

11. The carry case of claim 10, wherein the stand member is a ring.

12. The carry case of claim 11, wherein the free end of the ring has a flat outer portion.

13. The carry case of claim 10, wherein the hinge is a pivot hinge.

14. The carry case of claim 10, wherein an inside surface of each of the front and rear walls are covered by a liner.

15. The carry case of claim 12, wherein the liner is made of felt.

16. The carry case of claim 10 wherein the carry case further includes a bottom indent opposite the top indent, and wherein the top indent follows a parabolic curve along the top of the carry case and the bottom indent follows a parabolic curve along a bottom of the carry case.

17. The carry case of claim 16, wherein the top indent is configured such that only the middle upward undulation of the flexible bridge of the clip-on glasses is exposed by the top indent when the clip-on glasses are fully inserted into the carry case.

18. The carry case of claim 10, wherein the middle upward undulation of the flexible bridge of the clip-on glasses comprises a lateral extension at a top of the middle upward undulation.

19. A clip-on glasses system, comprising:
a pair of clip on glasses having a right lens portion and a left lens portion that are joined by a flexible bridge having a serpentine shape, the serpentine shape including a plurality of upward and downward undulations, including a middle upward undulation, the pair of clip on glasses having a maximum width across the right and left lens portions;
a carry case for receiving and retaining the pair of clip-on glasses, having:
a front wall and a rear wall that are parallel;
a sidewall that extends between the front wall and rear wall around a bottom of the front wall and rear wall, and which extends upward around a right side and a left side of the front wall and rear wall to a right side end point and a left side end point, wherein a distance between the left side end point and the right side end point is less than the maximum width across the right and left lens portions of the clip-on glasses and is less than a maximum distance from a left side to a right side inside the carry case, and wherein the maximum distance from the left side to the right side inside the carry case is closer to a bottom of the carry case than are either the right side end point and left side end point of the sidewall; and
wherein the carry case has a top indent portion form along a top of the carry case that is configured such that the middle upward undulation of the clip on glasses is exposed by the top indent when the clip-on glasses are fully inserted into the carry case.

20. The system of claim 19, wherein the carry case further includes a stand disposed on the rear wall and including a stand member having an attached end that is attached to the rear wall of the carry case at a hinge, and further having a free end opposite the attached end.
